(19) United States
(12) Patent Application Publication
(10) Pub. No.: US 2003/0203166 A1
(43) Pub. Date: Oct. 30, 2003

(54) Shrinkable polymeric labels

(76) Inventor: Peter J. Dronzek, Thornwood, NY (US)

Correspondence Address: James V. Costigan, Esq., Hedman & Costigan, P.C., Suite 2003, 1185 Avenue of the Americas, New York, NY, 10036-2646, US

(21) Appl. No.: 10/435,980

(22) Filed: May 12, 2003

Related U.S. Application Data
(63) Continuation of application No. 08/018,241, filed on Feb. 16, 1993, now Pat. No. 5,343,984.

(51) Int. Cl. B32B 27/00

(52) U.S. Cl. 428/195.1

(57) ABSTRACT

The present invention provides a process for labeling a surface with a shrinkable polymeric label, said method including the steps of:

(a) printing indicia on at least one surface of a shrinkable polymeric label substrate with a printing composition which imparts anti-static properties to said shrinkable polymeric label substrate;

or printing indicia on a shrinkable polymeric label substrate on a surface which may or may not have a layer of an anti-static agent, said shrinkable polymeric surface having a layer of an anti-static layer on at least one surface;

or printing indicia on a shrinkable polymeric label substrate which has dispersed therein an anti-static composition;

(b) cutting the product of step (a) into discrete labels; and

(c) contacting a surface to be labeled with said shrinkable polymeric label to attach said shrinkable layer to said surface; and

(d) shrinking said polymeric label on said surface.

### FIELD OF THE INVENTION

This invention relates to polymeric sheets or rolls particularly adapted for use as shrink labels in the post mold labeling of plastic, glass or metal containers or surfaces. More particularly, the present invention relates to shrinkable polymeric film substrates adapted for printing that also have surface layers that adapt the film labels for use in cut and stack labeling applications. In another aspect, the invention relates to such labels which possess the beneficial properties of the known roll fed plastic shrink labels that can be applied using hot melt adhesive, thermally activated sealable adhesives, water based adhesives, solvent seam bonding or a combination of these techniques on conventional cut label wrap around application equipment.

### BACKGROUND OF THE INVENTION

Plastic, glass and metal containers or bottles are prevalent in a wide variety of shapes and sizes for holding many different types of materials such as detergents, chemicals, motor oil, beer, etc. These containers are glass, coated steel, aluminum or plastic (mono or multi layers) of polyethylene, polypropylene, polyester or polyvinyl chloride resin along with other specialty blends for specific barrier and product resistance performance.

Generally such containers are provided with a label which designates the trade name of the product and may contain other information as well. The early art which still is prevalent today employed the use of labels manufactured from paper substrates that were applied with a water based adhesive. Subsequently, dry pressure sensitive self adhesives and in mold labels manufactured from paper have been and continue to be used. The shortcomings of paper labels with regard to tearing, wrinkling, creasing and the like due to age and moisture, or due to a lack of deformability when applied to a deformable plastic substrate have been well documented in the labeling industry. Because of this and the need to produce recyclable plastic containers, over the years a great deal of effort has been expended to develop container decoration techniques and durable film substrates which would overcome these shortcomings.

Film facestocks for container decoration which have resulted from these efforts can be applied to glass and plastic containers as self adhesive pressure sensitive labels as described in the prior art. The use of self adhesive paper and film “pressure sensitive adhesive” (PSA) labels that have been preprinted and supported on a release liner is not a cost effective option because of the added cost of the release liner used to support and render processable the self adhesive face stock. The cost of this type of structure combined with the added cost of disposal of the liner does not make pressure sensitive labeling a desirable option from an economic or environmental standpoint.

Another film face stock labeling technique that has evolved is the use of heat activated in-mold labels as described in the prior art where a preprinted plastic label with a heat activated adhesive is placed in the mold before the molten plastic resin is injected or blown into the mold cavity at elevated temperature and pressure which activates the adhesive and fuses the label substrate to the container in-mold. The use of film based in-mold label substrates presents a more cost effective alternative then self adhesive pressure sensitive labels in terms of substrate cost but as this technology has progressed, it has been found that productivity is impacted by the label feeding step into the mold which is performed in a complex, continuous and rapid manner which results in large amounts of scrap material. Also, the initial capital investment required to tool up for a container specific in-mold label process for new molds and the complex electromechanical maintenance intensive feeding devices is significant. Another detriment for this process is the potential inventory carrying costs for varieties of labeled containers that come into play with predecorated containers such as in-mold for those who would choose to apply the label immediately pre or post filled.

Post mold decoration of glass and plastic containers in the prior art can also be accomplished by direct printing on the container. Direct printing on the container is not a cost effective process for low volume applications and also presents the aforementioned inventory problems along with added cost for freight to and from a container printer. It is becoming more difficult for commodity products to support the cost of this labeling technique.

Another post mold technique that is known is the “Therimage” process. This process transfers a reverse printed image from a transfer release sheet under temperature and pressure to produce decorated containers. The “Therimage” technique of transferring a reverse printed image is costly because of transfer sheet costs and presents the same disposal problems and costs with the transfer sheet as occurs with the aforementioned release liner used in conjunction with self adhesive labels. Graphic design and quality is limited with this technique.

Roll fed wrap around labeling is another technique employed in the current art where paper and polymer substrates are affixed to produce decorated containers. With this technique, rolls of clear or opaque preprinted monolayer or laminated structures are used to feed labeling machines known to those in the art which cut individual labels from rolls that are affixed to containers such as beverage bottles, coffee cans and the like. Graphic design and quality while more than acceptable, is limited with roll printing techniques employed versus what is possible with sheet fed four color process lithographic printing. Roll fed labeling machines are more complex in design and operation because labels must be cut in register from a roll at high speed versus conventional precut or “cut and stack” labeling where a precut or registered label is picked from a stack in cut sheet form and applied to a container.

A further enhancement in roll fed labeling evolving in recent years is the use of “roll-on-shrink-on” film substrates. The polymeric film substrates are manufactured with a shrink property which causes it to shrink a controlled amount when exposed to certain temperatures. The labels shrink and tightly conform to the container surface. In roll fed shrink labeling, the label is typically affixed to the container using a hot melt adhesive which is applied to the label substrate or container in a molten state. The hot melt adhesive anchors the leading edge of the label with the container. The container is then wrapped with the body of the label, cut to register and the trailing edge is affixed either with hot melt adhesive or aqueous cold glue adhesives to the container or lapped over the leading edge. The label is married to the container while the hot melt adhesive is molten, the adhesive cools, it sets up and bonds the label substrate to the container. Complete wrap around hot melt applied labels where one end of the label is affixed to the container while the other end is wrapped around the container and affixed with hot melt or aqueous cold glue to the container or preferably wrapped over the label substrate is proven label application technology that works well for film and paper label substrates including roll fed shrink film substrates. Wrap around labelers such as the Krones ContiRoll®, Associated Packaging “Polyclad” labeler, and machines from Trine Labeling Systems and B&H Machine are used for roll fed labeling. In applications where “roll-on-shrink-on” films are applied, a heat and shrink apparatus to shrink the film is located after the label application machine. The apparatus can be banks of hot air guns or an oven section to heat the monolayer film or shrink film laminate to the desired shrinkage. The temperature and residence time in the shrink section are dictated by the shrink properties of the film and the degree or shrinkage required for the label to shrink to the contour of the container.

The object of this invention is to use cut and stack wrap around labelers such as the Krones Canmatic (hot melt adhesive), machines from F. N. Burt (hot melt and aqueous cold glue), Anker Machinery (hot melt and aqueous cold glue) and others such as machines that will apply heat activated labels or solvent seam sealable labels to apply shrink film labels in a precut format from a stack, not from a roll fed labeler which is known. The various machine designs and techniques of cut and stack labelers are well known within the labeling industry and to those skilled in the art. The “Krones Manual Of Labeling Technology” by Hermann Kronseder dated December 1978, is hereby incorporated by reference.

Roll-on-shrink-on labels or shrink films in the current art are applied with specialized continuous roll fed labelers where the label is cut from the roll in register on the labeler. This approach complicates the labeling equipment and process and also limits the quality of the graphics possible by limiting the printing processes that can be employed and requires new labeling equipment for the switch from a conventional precut wrap around label to a roll fed wrap around shrink label.

### SUMMARY OF THE INVENTION

In considering the performance or economic shortcomings of prior art materials and processes, I have discovered a process by which a surface may be labeled with a shrinkable polymeric label by means of a conventional cut and stack labeling apparatus, said method comprising the steps of:

(a) printing indicia on at least one surface of a shrinkable polymeric label substrate with a printing composition which imparts anti-static properties to said shrinkable polymeric label substrate; or printing indicia on a shrinkable polymeric label substrate on a surface which may or may not have a layer of an anti-static agent, said shrinkable polymeric label having a layer of an anti-static agent on at least one surface; or printing indicia on a shrinkable polymeric label substrate which has dispersed therein an anti-static composition;

(b) cutting the product of step (a) into discrete labels; and

(c) contacting a surface to be labeled with said shrinkable polymeric label to attach said shrinkable layer to said surface; and

(d) shrinking said polymeric label on said surface.

The invention also includes a shrinkable polymeric label which comprises a cut label comprising: (a) a shrinkable polymeric label substrate which is printed with indicia which imparts anti-static properties to said shrinkable polymeric label substrate or (b) a shrinkable polymeric label substrate which has a layer of an anti-static agent on at least one surface and printed indicia on at least one surface which may or may not have an anti-static layer; or (c) a shrinkable polymeric label substrate which has dispersed therein an anti-static composition.

The embodiment (b) above includes a label where the printed indicia is on one side and the anti-static layer on the opposite side; printed indicia is on one side over an anti-static layer; and anti-static indicia is on one side and an anti-static layer is on the opposite side.

Accordingly it is an object of the invention to provide a shrinkable polymeric label particularly adapted for use in cut and stack wrap around labeling of polymeric, glass and metal containers that would readily feed from the label magazine or gripper, adhere and shrink after exposure in a shrink apparatus to conform to the contour of the container.

It is also an object of the invention to provide a shrinkable polymeric label particularly adapted for use in cut and stack labeling of polymeric, glass and metal containers that would apply on existing cut and stack wrap around label application equipment and shrink with the addition of a shrink apparatus after the labeler to heat the label to a temperature sufficient to achieve the desired shrink characteristics for the subject container.

It is also an object of the invention is to provide a shrinkable polymeric label for use in cut and stack applied wrap around labeling of polymeric, glass and metal containers that would have preferential shrinkage in either the machine or transverse direction as dictated by the type of container being labeled, the label graphics and the orientation (machine or transverse direction) of the graphics on the shrink film substrate before it is cut.

It is also an object of the invention to provide a shrinkable polymeric label for use in cut and stack applied wrap around labeling which would combine suitable properties of modulus of elasticity and flexibility and would not be degraded by handling and flexing of the subsequent container.

Finally, it is an object of the invention to provide a shrinkable polymeric label for use in cut and stack wrap around labeling of polymeric containers which does not have to be removed from such containers in order to recycle or regrind defective or post consumer polymeric containers.

### DETAILED DESCRIPTION OF THE INVENTION

Shrinkable polymeric label substrates known in the prior art are typically thin gauge materials that can be handled and applied in roll or continuous web format, but can not be readily handled and applied with quality and efficiency in a single precut format because the shrinkable polymeric label substrate does not have sufficient stiffness to be correctly picked, transported and placed at high speed.

Labeling apparatus which is used to apply precut or “cut and stack” wrap around paper labels is well known to those in the art. A polymeric shrink film label substrate with sufficient stiffness as dictated by the size of the label with paper like and/or anti-static surfaces can be applied on conventional paper cut and stack wrap around labeling apparatus and subsequently shrunk to conform to the contour of the container. The polymeric shrink film label substrate will provide a label with printability, chemical resistance and resistance to cracking, tearing, creasing, wrinkling or any other degradation of the sort experienced by paper labels due to physical or environmental extremes.

The invention also permits the use of sheet fed printing processes such as lithographic printing using ultra violet (UV) curable inks and natural and synthetic oxidation curing systems with the paper like or anti-static surfaces. In addition, polymeric shrink labels produced on conventional gravure, rotary screen and flexographic roll printing equipment used to produce the roll-on-shrink-on labels of the prior art can be cut in register into individual labels, stacked and applied via cut and stack labeling equipment to a container if the shrinkable polymer has the proper paper like or anti-static surface or overcoat. As used herein the reference to the technique of labeling a “container” includes the technique of labeling a surface. It is contemplated that the most common applications of the invention will be for labeling objects made of glass, plastic or metals such as bottles, cans or containers.

Optionally, if a metalized coating of a thin metal film is deposited on the polymeric sheets or rolls, premium quality decorative labels with all of the advantages set forth above will be provided.

The paper like or anti-static polymeric film surface treatment will be applied in the present invention to the selected polymeric sheet in a continuous or patterned layer to enable polymeric sheets to be successfully used as label substrates when applied using precut labeling techniques. The surface treatment which may be applied by either a coating or an extrusion technique, has the function of providing a static free surface for the separation of labels in a stack where the top label in the stack can be separated from the label beneath it as it is being removed from the stack of labels in the magazine without generating static or picking more than one label.

In a preferred embodiment, the surface layer will be formulated for optimum printability and adhesive adhesion in addition to the anti-static properties required for performance in printing, sheeting, jogging, cutting and label transfer from a magazine. In a second preferred embodiment, the surface layer will be compatible with lithographic ink systems where superior process graphics can be achieved. It is also possible to coextrude a polymeric paper like anti-static surface layer with the base polymer film layer.

The choice of polymeric substrate for the label film will determine the rigidity, shrinkability, deformability or conformability, regrindability and printability required for application to the selected container.

The term “shrinkable polymeric label substrate” as used herein should be taken for purposes of the present invention to be a shrinkable and conformable polymeric substrate with at least one surface layer that has sufficient anti-static and slip characteristics where labels can be die cut in register, stacked, placed in a magazine, individually picked, affixed and wrapped around a container at high speed. Similarly, the “surface layer” previously mentioned has the properties of printability, anti-static, slip and adhesion to the labeling adhesive. Examples of shrinkable polymeric films used in roll-on-shrink-on applications that can be adapted for use as cut and stack film applied labels with the addition of the proper surface layer include olefin polymers such as polyethylene, polypropylene and polyvinyl chloride films having a thickness of about 0.75 to 20 mills, preferably 1.5 to 4 mills. Commercially available products which may be used in the present invention include:

AET FILMS

VISION 306 CLS TRANSPARENT POLYPROPYLENE

SHRINKAGE 8% MD @ 275° F., <5% TD @ 275° F.

GAUGE 1.0 MILS

AET FILMS

VISION 325 WLS WHITE POLYPROPYLENE

SHRINKAGE 9% MD @ 275° F., <5% TD @ 275° F.

GAUGE 1.35 MILS

AET FILMS

VISION 370 WLS WHITE POLYPROPYLENE

SHRINKAGE 9% MD @ 275° F., <5% TD @ 275° F.

GAUGE 1.2 MILS

AET FILMS

VISION 345C TRANSPARENT POLYPROPYLENE

SHRINKAGE 12% MD @ 248° F., 25% MD @ 284° F., 0% TD

GAUGE 0.89 MILS

AET FILMS

VISION 370W WHITE POLYPROPYLENE

SHRINKAGE 16% MD @ 248° F., 25% MD @ 284° F., 0% TD

GAUGE 1.20 MILS

TRICO INDUSTRIES INC

SHRINK-RITE 1.4 TRANSPARENT POLYPROPYLENE

SHRINKAGE 11% MD @ 212° F., 30% MD @ 280° F., 0% TD

GAUGE 1.40 MILS

TRICO INDUSTRIES INC

SHRINK-RITE 2.0 TRANSPARENT POLYPROPYLENE

SHRINKAGE 11% MD @ 212° F., 30% MD @ 280° F., 0% TD

GAUGE 2.00 MILS

YOOJUWANG

CLEAR SHRINK VINYL

SHRINKAGE 4% MD @ 212° F., 54% TD @ 212° F.

GAUGE 2.75 MILS

BONSET AMERICA

CLEAR SHRINK VINYL

SHRINKAGE 3% MD @ 212° F., 52% TD @ 212° F.

GAUGE 2.75 MILS

MOBIL CHEMICAL

LABEL-LYTE ROSO 30LRX447 CLEAR POLYPROPYLENE

SHRINKAGE 18% MD @ 275° F., 2% TD @ 275° F.

GAUGE 1.2 MILS

MOBIL CHEMICAL

LABEL-LYTE ROSO 50LRX400 WHITE POLYPROPYLENE

SHRINKAGE 18% MD @ 275° F., 0% TD

GAUGE 2.00 MILS

MOBIL CHEMICAL

LABEL-LYTE ROSO 30LRX400 WHITE POLYPROPYLENE

SHRINKAGE 18% MD @ 275° F., 0% TD

GAUGE 1.20 MILS

The published data sheets for the AET, Mobil and Trico products are hereby incorporated by reference.

It is also an aspect of the present invention that the shrinkable polymeric label substrate may comprise laminated layers of shrinkable polymeric films designed for and used in roll-on-shrink-on applications. The Trico and Mobil films listed above are designed and used for roll-on-shrink-on applications and do not have sufficient stiffness as a stand alone layer to function consistently in cut and stack applications for a large label. When combined in a lamination, the laminated shrinkable composite will have sufficient stiffness for high speed dispensing from a magazine and will apply without wrinkling, puckering or creasing. The stiffness of the label substrate required depends on the size of the label, the speed of application and the labeling equipment being used. The only real practical test of label stiffness for a given label size, specific container and label application machine is to produce the label and try it on the machine at desired line speeds. From experience with different size labels, substrate stiffness, degree of shrink, varying size containers and precut label labeling machines, one can logically determine the best polymeric shrink film substrate to try, but the proof is in the successful application of a label to the container and subsequent shrinkage of the substrate to conform to the container. For a guide, typical cut and stack paper labels have the following stiffness properties on a Gurley stiffness tester before printing: Provincial Paper-60#/3,000 sq. ft. clay coated on one side -MD (machine direction) stiffness 150.96 mg. transverse direction (TD) stiffness 85.58 mg.

Any shrinkable polymeric label structure with stiffness characteristics in the range of the Provincial paper will machine well in terms of stiffness. It has been found through experimentation that polymeric substrates that have an MD stiffness of a minimum of 25 mg and a TD stiffness of 50 mg. will function well in existing cut and stack labeling equipment in most applications. For example, the Shrinkrite 2.0 white and clear products have stiffness readings of approximately 17.5 mg. in the MD and 7.75 mg in the TD and large labels will not successfully feed at high speed through a cut and stack labeler because of wrinkling and puckering while a lamination of two layers of either substrate where the stiffness of a polypropylene substrate typically increases as a cube of the thickness will successfully feed.

The invention requires the use of a printed shrinkable polymeric substrate which has anti-static properties on at least one surface. Printable paper like coatings such as acrylic, polyurethane, epoxy, ethylene vinyl acetate and other binder resins filled with pigments and/or finely divided clay, calcium carbonate or silica are known to those in the art and these materials are commonly applied to paper and other substrates. These can be used to coat the shrinkable polymeric substrate and they will also impart anti-static properties required for cut sheet applied shrinkable polymeric labels.

The shrinkable polymeric substrate may have a surface layer which comprises an anti-static agent on at least one side to be used in a precut format on cut and stack labeling equipment instead of on a roll fed labeler in a roll-on-shrink-on application. When considering the choice of the material which forms the functional layer which may be applied by coating, coextrusion or extrusion, one must consider the label substrate, container to be labeled, labeling machinery, type of adhesive application technique if an adhesive is employed @ and down stream processing requirements such as filling, conveying and packing. In addition, the final appearance of the label such as the clear no label look or a plain opaque label must be considered in the choice of the components of the surface layer. The label indicia may be reverse printed on a clear substrate and laminated to an opaque layer, e.g. white, to make a label having a protective front surface. Generally, a deposit of from 0.05 to 8 lbs./3000 sq. ft. of a surface layer comprising the anti-static agent may be employed on the polymeric film, depending on the particular material that is selected.

The choice of the surface layer, label substrate stiffness, clear or opaque label, container geometry, degree of shrink required, shrink apparatus to heat the label on the container, plant processing conditions after labeling, storage requirements, recyclability and the end use requirements that must be met such as high temperature resistant or ice proof adhesives are important considerations. There are many more specific variables within these considerations all of which influence the choice of polymeric shrink film substrate and the functional surface layer applied to at least one side, preferably two sides for a specific application. It is clear that one specific anti-static layer may not fit all applications but the layers can be tailored to particular needs based on the conditions and requirements discussed above.

For a coextruded product, where the functional layer is formed on the shrink film through coextrusion, an adhesion promoting tie layer can be employed. Materials such as maleic anhydride, ethyl acrylic acid and the like may be employed as the tie layer. For a coated product where the functional coating is applied to the shrinkable polymeric substrate through a coating process, an adhesion promoting primer can be employed. Materials such as chlorinated polypropylene, polyethylene-imine (PEI) and the like may be employed at levels of 0.03-1.0 lb./3000 sq. ft. as a separate coated tie layer. A coextruded adhesion promoting tie layer can be used to achieve adhesion of the coated functional layer.

It is also contemplated through this invention to use an extruded monolayer shrinkable polymeric substrate with additives such as but not limited to those used in coextruded layers that impart functional anti-static properties and printability throughout the entire film which renders both surfaces anti-static and printable. The anti-static layer must be printable and non blocking.

In the anti-static layer, slip and anti-blocking compounds can be employed to prevent excessive friction between the layer on the back side of the label layer and the front side of the printed label below it in the stack to insure trouble free operation of the high speed automated machinery which is used to pick the labels from the magazine and apply them to containers. The anti-static layer also aids in sheet fed printing processes where static, slip and blocking are also considerations. Other additives that may be used at a level of 0.1-50% by weight of the anti-static layer composition are materials such as microcrystalline wax emulsions, erucamide dispersions, polytetrafluoroethylene compositions, silicone beads, modified silicone solutions, parafin wax emulsions, high melting polypropylene emulsions, carnauba wax emulsions, oxidized ethylene/EVA compositions, micronized polyethylene wax/PTFE emulsions, micronized polypropylene, micronized fluorocarbons such as PTFE (Teflon), micronized polyethylene, silica and talc which are used for their known functions.

The anti-static agent may be present at a level of 0.1-100% by weight of the anti-static layer composition where at a low level, the anti-static agent functions as an additive to the layer versus at a 100% level where the anti-static agent functions entirely as the layer. These materials include quaternary ammonium salts such as Ethoquad C/12, sulfonated styrene maleic anhydride, sulfonated polystyrene, sulfonated vinyl toluene maleic anhydride, conductive polymers and organo modified silicones such as Silwet L77 which may be applied as aqueous dispersions to achieve the desired coating level. The anti-static agent may be applied in a pattern such as a XY grid or it may be applied to 100% of the surface.

Protective coatings may be used over the printed surface of the shrinkable polymeric label to protect the exposed polymer film of the label and the printed indicia when applied at a level of 0.1-5.0 lbs./3000 sq. ft. using conventional application techniques. These materials include styrenated acrylics such as OC1043 from O.C. Adhesives Inc., urethanes such as AS455 from Adhesion Systems Inc., Flexcon Release Varnish from Manders—Premier and other protective coatings or varnishes known to those in the art.

Typically, the cut and stack wrap around shrink label will be affixed to the container using a hot melt adhesive of the type currently used to affix roll-on-shrink-on labels of the current art. It is also contemplated that heat activated adhesives with hot shear strength, or solvent sealable adhesives where the face and back side of the label seal or melt together when in intimate contact with a judiciously selected solvent in the overlapped area of the label after the container is wrapped around can be used. In the current roll-on-shrink-on art, the shrinking apparatus typically is located in close proximity directly after the labeler. It is further contemplated that aqueous adhesives that do not immediately set up to a permanent bond can be used to affix the label to the container which would dry over time and can then be shrunk through a shrinking apparatus at a later date. Labels do not necessarily have to be shrunk right after application. Usually a sufficient area of one end of the label to form a firm adherent bond, when the label is wrapped around the container, has an adhesive layer because the label is overlapped. If the label is not overlapped, then both ends of the label will have a sufficient amount of adhesive to adhere to the container before and after the label is heat shrunk to form a snug fit on the container.

In the alternative, the label may be formed into a tubular form which is formed on the surface of the container by wrapping the container with the label and sealing the edges using an adhesive or a melt bonding of the surfaces of the end portions of the labels. In the alternative the tubular form may be made by wrapping the printed label on a mandrel before heat sealing the ends of the label prior to placing the pre-formed tubular label over the over the container to be labeled. If this technique is used, no adhesive is required.

A preferred aspect of this invention uses laminations of roll-on-shrink-on films to build composite shrinkable film substrates of sufficient stiffness to function on conventional pre-cut magazine fed cut and stack labeling equipment typically used for paper labels. It should be noted that for films used in roll-on-shrink-on labeling, stiffness is not a critical parameter since the film is applied from a continuous roll in web form with tension controls where handling a flexible thin film is proven art. Any lamination of shrinkable polymeric labels with at least one functional surface must have non curling characteristics in addition to stiffness for optimum feeding characteristics. It is preferred to use an anti-static printable layer on both sides of the polymeric shrink film substrate to enhance printing and the high speed labeling of pre-cut labels from a stack. While any conventional printing process is acceptable depending on the quality of the graphics required, special mention is made of the sheet fed lithographic process where short runs of high quality graphics can be done for cut and stack labels where the types of surface polymeric films also can enhance lithographic sheet printing.

Cut and stack applicable polymer shrink labels can also be produced using the roll fed gravure and flexographic printing processes as used for the current roll-on-shrink-on labels. This can be accomplished by having the ant-stat and slip layer applied over the ink or on the back side after printing for surface printed labels or applied to the polymeric surface or surfaces for laminated labels where the printed image is buried in the laminate. The labels are then cut in register to produce die cut single sheets of labels which are then stacked for labeling from a magazine. This invention allows the use of current polymeric shrink films preferably used in a lamination for roll-on-shrink-on applications to be treated with a surface layer for cut and stack label application. This will allow current cut and stack label users to switch to a shrinkable label with just the addition of a shrink apparatus and not the addition of an expensive and operationally complex roll-on-shrink-on label machine.

### DESCRIPTION OF THE PREFERRED EMBODIMENTS

### EXAMPLE

A 2 mil heat shrinkable polypropylene film (Shrink-Rite, Trico Industries) is primed with a 0.2 g/1000 sq. in. (MSI) coating of polyethylene imine (Polymin-P, BASF) and then overcoated with 2.5 g/1000 sq. in. (MSI) of the composition of Formula A

Formula A

| | Parts by Weight |
|---|---|
| Styrene acrylic resin emulsion | 32 |
| (Rhoplex P554, Rohm & Haas) | |
| Kaolin Clay | 30 |
| (ASP 400 Engelhard Corp.) | |
| Defoamer | 0.6 |
| (Colloid 999, Rhone Poulenc) | |
| Wetting Agent | 0.6 |
| (Surfynol 440, Air Products & Chemicals) | |
| Anti-static agent | 1.0 |
| (Ethoquad C/12, Akzo Chemical Co.) | |
| Slip aid, Anti-Static agent | 0.5 |
| (Silwet L77, OSI Specialties) | |
| Anionic polyethylene emulsion (slip aid | 0.5 |
| and anti-block aid) | |
| (Chemical Corp. of America) | |
| Sod. lithium magnesium silicate | 0.3 |
| (thickener and anti-static aid) | |
| (Laponite RD, Southern Clay Prods.) | |
| Propylene glycol | 3.0 |
| Water | 31.5 |

The coated shrinkable polypropylene is printed with a label text and cut to the size which may be affixed to a 12 ounce contoured beverage container with a hot melt adhesive (Adhesion Systems Inc. EVA based hot melt BL1001). The label is adhered to the container and the container is then exposed to a hot air source which is sufficient to shrink the label to snugly fit the surface of the contoured beverage container.

I claim:

1. A process for labeling a surface with a shrinkable polymeric label, said method comprising the steps of:
(a) printing indicia on at least one surface of a shrinkable polymeric label substrate with a printing composition which imparts anti-static properties to said shrinkable polymeric label substrate;
or printing indicia on a shrinkable polymeric label substrate on a surface which may or may not have a layer of an anti-static agent, said shrinkable polymeric surface having a layer of an anti-static agent on at least one surface;
or printing indicia on a shrinkable polymeric label substrate which has dispersed therein an anti-static composition;
(b) cutting the product of step (a) into discrete labels; and
(c) contacting a surface to be labeled with said shrinkable polymeric label to attach said shrinkable layer to said surface; and
(d) shrinking said polymeric label on said surface.

2. A process as defined in claim 1 which includes the step of stacking said labels.

3. A process as defined in claim 1 including the step of loading said label stack into the feed magazine of a cut and stack labeler.

4. A process as defined in claim 1 where a clear layer of shrinkable polymeric label substrate is applied over the printed indicia to capture said printed indicia between two layers of shrinkable polymeric shrink substrate.

5. A process as defined in claim 1 wherein the label is affixed to the container by using a hot melt adhesive, heat sealable adhesive, water based adhesive, solvent combining bond or a combination.

6. A process as defined in claim 1 wherein the label is affixed to the container without an adhesive.

7. A process as defined in claim 1 wherein the label is applied to a glass container.

8. A process as defined in claim 1 wherein the label is applied to a plastic container.

9. A process as defined in claim 1 wherein the label is applied to a metal container.

10. A process as defined in claim 1 wherein the anti-static agent is a coated, coextruded or extruded layer.

11. A process as defined in claim 1 wherein the anti-static effect is provided by the printed indicia or indicia protective coating.

12. A process as defined in claim 1 wherein the anti-static layer is a coated layer applied with 100% coverage.

13. A process as defined in claim 1 wherein the anti-static layer is a coated layer applied in a pattern.

14. A process as defined in claim 1 wherein the shrinkable polymeric label substrate is a mono-layer or coextruded film selected from clear, opaque or colored polypropylene, polyethylene or polyvinyl chloride.

15. A shrinkable polymeric label which comprises a cut label comprising: (a) a shrinkable polymeric label substrate which is printed with indicia which imparts anti-static properties to said shrinkable polymeric label substrate or (b) a shrinkable polymeric label substrate which has a layer of an anti-static agent on at least one surface and printed indicia on at least one surface which may or may not have an anti-static layer; or (c) a shrinkable polymeric label substrate which has dispersed therein an anti-static composition.

16. A shrinkable polymeric label as defined in claim 15 comprising a shrinkable polymeric label substrate which is printed with indicia which imparts anti-static properties to said shrinkable polymeric label substrate.

17. A shrinkable polymeric label as defined in claim 15 comprising a shrinkable polymeric label substrate which has a layer of an anti-static agent on at least one surface and printed indicia on at least one surface which may or may not have an anti-static layer.

18. A shrinkable polymeric label substrate as defined in claim 15 which has dispersed therein an anti-static composition.
